(19) United States
(12) Patent Application Publication
(10) Pub. No.: US 2011/0236739 A1
(43) Pub. Date: Sep. 29, 2011

(54) BATTERY PACK

(75) Inventors: Masayuki WATANABE, Kariya-city (JP); Hisato Inoue, Anjo-city (JP); Fumiaki Murakami, Okazaki-city (JP); Naoki Hiraiwa, Toyokawa-city (JP); Humihiro Kuzuhara, Yokkaichi-city (JP)

(73) Assignee: DENSO CORPORATION, Kariya-city (JP)

(21) Appl. No.: 13/069,609

(22) Filed: Mar. 23, 2011

(30) Foreign Application Priority Data
Mar. 24, 2010 (JP) 2010-68811
Feb. 22, 2011 (JP) 2011-36160

(51) Int. Cl. H01M 2/10

(52) U.S. Cl. 429/99

(57) ABSTRACT

A battery pack is disclosed. The battery pack includes angular-shaped battery cells stacked in a stack direction and a battery holder device. The battery holder device presses side surfaces of the battery cells with a load acting along the stack direction. The battery holder device integrally includes multiple surface pressing members each interposed between adjacent battery cells and multiple connection members each connecting adjacent surface pressing members. Rigidity of each connection member against the load acting along the stack direction is smaller than rigidity of each surface pressing member against the load acing along the stack direction.

### CROSS REFERENCE TO RELATED APPLICATION

The present application is based on and claims priority to Japanese Patent Application No. 2010-68811 filed on Mar. 24, 2010 and Japanese Patent Application No. 2011-036160 filed on Feb. 22, 2011, disclosures of which are incorporated herein by reference.

### BACKGROUND OF THE INVENTION

1. Field of the Invention

The present invention relates to a battery pack, which includes an assembly of multiple stacked battery cells.

2. Description of Related Art

Patent Document 1 describes a conventional battery pack in which multiple flat battery cells are electrically connected in series with each other and are stacked. Multiple interlayer members are interposed between the stacked battery cells. The multiple interlayer members arranged between the battery cells are connected with each other via heat conduction members having a high thermal conductivity. The heat conduction members and the multiple interlayer members are integrally formed by, for example, aluminum die casting. The heat conduction members and the multiple interlayer members constitute a casing that serves as an outer shell member of the battery pack. The casing defines battery cell chambers for receiving the battery cells in spaces partitioned by the interlayer members. Each battery cell is integrated with the casing by being press-fitted into the battery cell chamber, thereby constituting the battery pack.
Patent Document 1: JP-2006-196230A

In the above conventional technique, however, since each battery cell is integrated with the casing by being press-fitted into the battery cell chamber, the size of each battery cell chamber in a stack direction needs to be comparable to or slightly smaller than the thickness size of the battery cell. In practice, the size of battery cell has a manufacturing variation, and it is difficult to manage a strict size relation between the battery cell chamber and the battery cell. In addition, if the size of battery cells has a variation, it causes a variation in surface pressure applied to side surfaces of respective battery cells at a time of binding the battery cells. In this case, it is impossible to obtain a binding force sufficient to integrate all of the battery cells.

### SUMMARY OF THE INVENTION

The present invention is made in view of the foregoing. It is an objective of the present invention to provide a battery pack that can adapt a battery cell thickness variation and that can obtain a binding force sufficient to integrate multiple battery cells.

According to an aspect of the present invention, a battery pack includes: multiple angular-shaped battery cells that are stacked in a stack direction; and a battery holder device that presses side surfaces, which are normal to the stack direction, of the multiple battery cells with a load acting along the stack direction to integrate the battery pack. The battery holder device integrally includes: multiple surface pressing members each interposed between adjacent battery cells so that the multiple surface pressing members press the side surfaces, which are normal to the stack direction, of the multiple battery cells; and multiple connection members each connecting adjacent surface pressing members, which are adjacent to each other in the stack direction. Rigidity of each connection member against the load acting along the stack direction is smaller than rigidity of each surface pressing member against the load acing along the stack direction.

According the above battery pack, the rigidity of the connection member against the load acting along the stack direction is smaller the rigidity of the surface pressing member. Thus, when an external force acts on the side surfaces, normal to the stack direction “X”, of the surface pressing members to bind the battery pack with a binding force compressing the battery pack from both sides of the battery pack along the stack direction “X”, the connection member with a small rigidity can be easily deflected. In this way, it is possible attain close contact between the battery cells and the surface pressing members, and it is possible to bind all of the stacked battery cells in a reliable manner. Therefore, the battery pack can adapt a battery cell thickness variation and can obtain the binding force sufficient to integrate the multiple battery cells.

### BRIEF DESCRIPTION OF THE DRAWINGS

The above and other objects, features and advantages of the present invention will become more apparent from the following detailed description made with reference to the accompanying drawings. In the drawings:

FIG. 1 is a perspective view of a battery pack of a first embodiment;

FIG. 2 is a plan view of the battery pack of the first embodiment;

FIG. 3 is a side view of the battery pack of the first embodiment;

FIG. 4 is a side view of the battery pack of the first embodiment viewed in a stack direction of battery cells;

FIG. 5 is a perspective view of a battery holder device used in the battery pack of the first embodiment;

FIG. 6 is a plan view of the battery holder device of the first embodiment;

FIG. 7 is a side view of the battery holder device of the first embodiment;

FIG. 8 is a side view of the battery holder device of the first embodiment viewed in the stack direction of the battery cells;

FIG. 9 is a perspective view of a battery pack of a second embodiment;

FIG. 10 is a perspective view of a battery holder device used in the battery pack of the second embodiment;

FIG. 11 is a plan view of the battery holder device of the second embodiment;

FIG. 12 is a side view of the battery holder device of the second embodiment;

FIG. 13 is a perspective view of a battery pack of a third embodiment before a busbar is mounted to a terminal part of a battery cell;

FIG. 14 is a perspective view of the battery pack of the third embodiment after the busbar is mounted to the terminal part of the battery cell;

FIG. 15 is a perspective view of a battery pack of a fourth embodiment;

FIG. 16 is a perspective view of a battery holder device used in the battery pack of the fourth embodiment;

FIG. 17 is a plan view of the battery holder device of the fourth embodiment;

FIG. 18 is a side view of the battery holder device of the fourth embodiment; and

FIG. 19 is a side view of the battery holder device of the fourth embodiment viewed in a stack direction of battery cells.

### DETAILED DESCRIPTION OF EMBODIMENTS

Embodiments of the present invention will be described with reference to the accompanying drawings. In the following, like numerical references are used to refer to like parts between embodiments. Duplicative explanation on like parts may be omitted if explanation is given in a preceding embodiment. If explanation on only a part of a configuration is given in one embodiment, another part of the configuration described in the preceding embodiment can be applied to the one embodiment. Parts in different embodiments can be combined not only when such a combination is explicitly shown but also when such a combination is not explicitly shown as long as the combination does not create contradiction.

### First Embodiment

A battery pack according to embodiments of the present invention can be used in, for example, a hybrid vehicle, which uses an internal combustion engine and a motor energized by an electric power charged in a battery as a driving power source thereof, an electric vehicle, which uses a motor as a driving power source thereof, or the like. A battery of the battery pack is, for example, a nickel-hydride secondary battery, a lithium-ion secondary battery, an organic radical battery or the like. The battery received in a casing may be arranged in a space underneath a seat of a vehicle, a space between a backseat and a trunk room, a space between a driver seat and a front passenger seat, or the like.

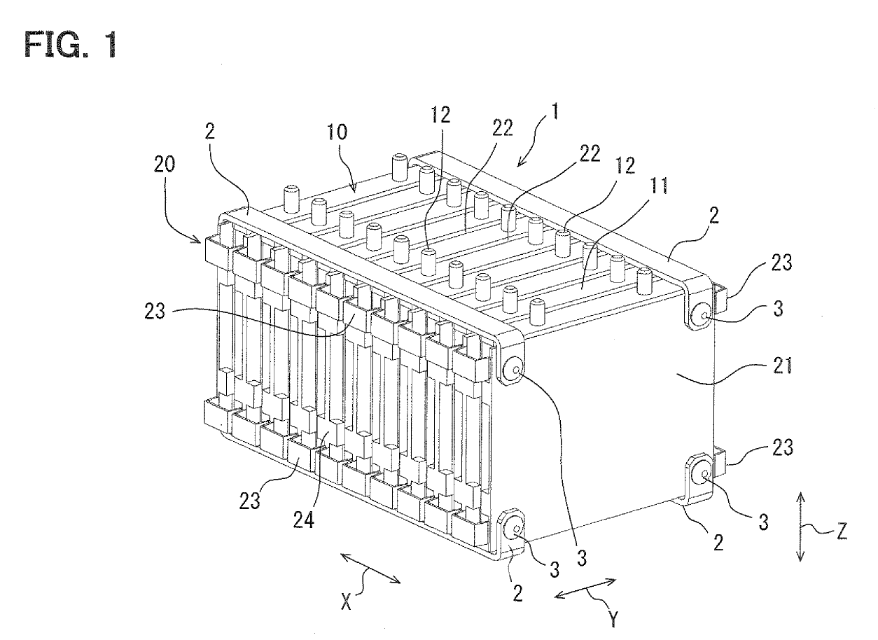

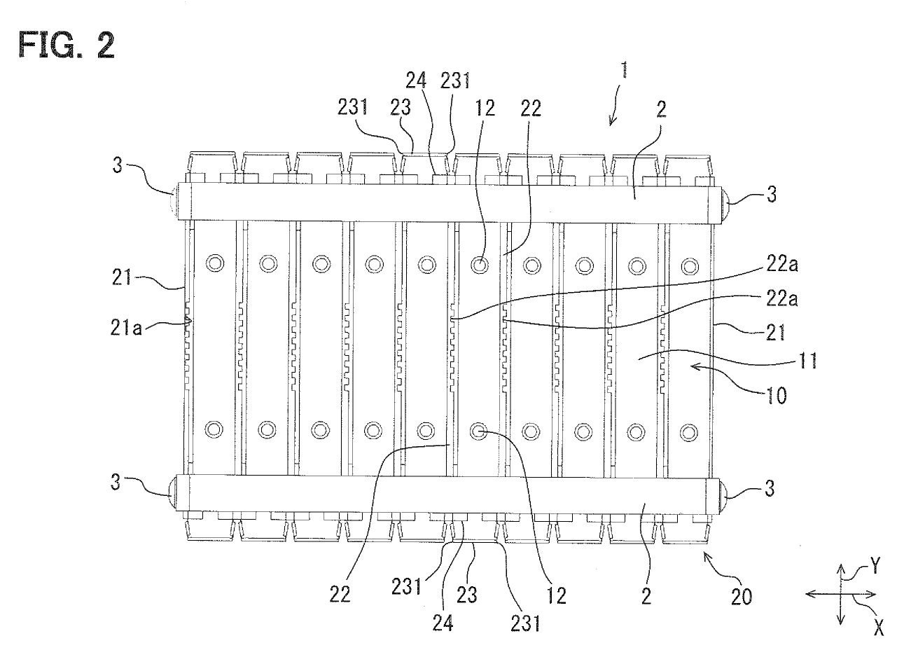

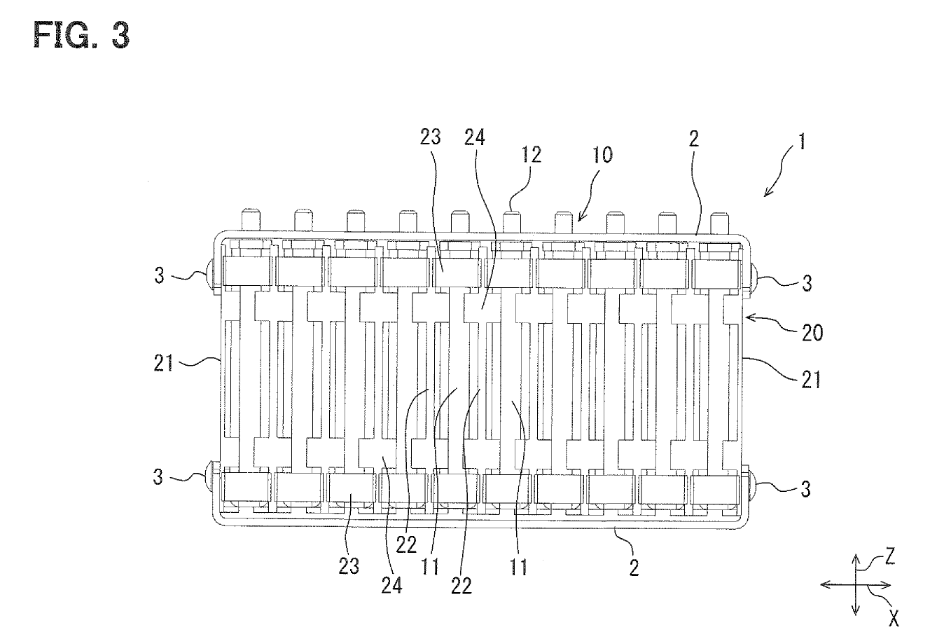

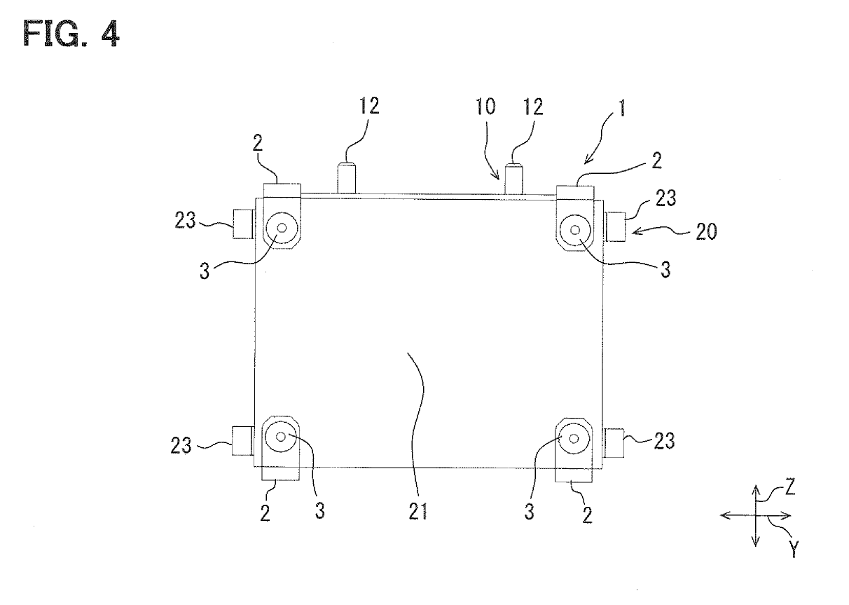

The first embodiment will be described below with reference to FIGS. 1 to 8. FIG. 1 is a perspective view of a battery pack 1 of the first embodiment. FIG. 2 is a plan view of the battery pack 1. FIG. 4 is a side view of the battery pack 1 viewed in a longitudinal direction “Y”. FIG. 4 is a side view of the battery pack 1 viewed in a stack direction “X” of battery cells 11. As shown in the drawings, a direction in which multiple battery cells 11 are stacked and arranged is defined as the stack direction “X”. A direction in which each rectangular battery cell 11 is elongated is defined as a longitudinal direction “Y”. A direction perpendicular to both of the stack direction “X” and the longitudinal direction “Y” is defined as a height direction “Z” (also called a vertical direction “Z” or an upper/lower direction “Z”).

The battery pack 1 including an assembly of multiple battery cells 11 is controlled by an electronic part (not shown), which may be used to charge and discharge the multiple battery cells 11 or control temperature of the multiple battery cells 11. The battery pack 1 is cooled by an air blown with a blower (not shown). In the battery pack 1, the multiple battery cells 11 are electrically connected in series with each other, and are arranged and stacked in the stack direction “X” so that side surfaces of the battery cells 11 normal to the stack direction “X” face each other. The battery pack 1 integrating therein the stacked battery cells 11 is received in a casing (not shown). The above-described electronic part may be an electronic component controlled by a DC/DC converter, a motor for driving a blower, or an inverter. Alternatively, the above-described electronic part may be an electronic control unit or the like. For example, the above-described electronic part may be operated by power adjusted by a power device acting as a switching power supply device.

The casing is rectangular cuboidal and has at least one member that is detachable for maintenance. The casing may be made of steel sheet or resin. The casing is provided with a mounting part for fixing the case to the vehicle by bolting or the like. The casing is further provided with a device reception box (not shown).

The device reception box houses a battery monitoring unit (not shown), a control device, a wiring harness for connecting devices, and the like. To the battery monitoring unit, results of various sensors for monitoring battery states (e.g., voltage, temperature etc.) are inputted. The control device is communicable with the battery monitoring unit. The control device controls power input/output of the DC/DC converter, and controls drive of the motor of the blower. The battery monitoring unit serves as a battery ECU (i.e., electronic control unit for a battery) for monitoring states of each battery cell 11, and is connected with the battery pack 1 via many wires.

As shown in FIGS. 1 to 4, each battery cell 11 is angular. The battery holder device 20 presses side surfaces of the battery cells 11 normal to the stack direction “X” (i.e., side surfaces parallel to the longitudinal direction “Y” and the height direction “Z”) to integrate the stacked battery cells 11 into a battery cell assembly. The battery holder device 20 holds and binds the multiple battery cells 11 in such manner that opposite end portions of the battery holder device 20, which are opposite to each other in the stack direction “X”, are connected by brackets 2, so that the multiple stacked battery cells 11 are subjected to compression forces caused by external forces in directions from the opposite end portions toward an inside between the end portions. Each of four brackets 2 serves as a belt-shaped binding device. The four brackets 2 are fixed to surface pressing members 21, which are located at the ends portion of the battery holder device 20. More specifically, the four brackets 2 are fixed to two upper portions and two lower portions of the surface pressing member 21 by a fixing means such as screws 3 and the like, respectively. The bracket 2 is made with a high strength material such as metal, hard resin and the like, so that the bracket 2 can press and integrate the multiple stacked battery cells 11 with a stable force.

Explanation will be given on the battery cells 11 of the battery pack 1. Each battery cell 11 is flat rectangular cuboidal. An outer peripheral surface of each battery cell 11 is covered by an exterior case made of an electrically-insulating resin. Each battery cell 11 is provided with two terminal parts 12 serving as a positive terminal and a negative terminal. The two terminal parts 12 are spaced apart from each other in the longitudinal direction “Y”, and are exposed so as to project from the exterior case in the height direction “Z”.

All of the battery cells 11 arranged in the casing as a whole in the above-described way are connected with each other. Specifically, respective terminal parts 12 of the battery cells 11 are connected by the busbar to enable current conduction from the negative terminal of a first end battery cell 11 to the positive terminal of a second end battery cell 11 via positive and negative terminals of middle battery cells 11 so that a current path extends back and forth in the battery pack 1 along the longitudinal direction “Y”. In the above, the first end battery cell 11 and the second end battery cell 11 are two of the multiple battery cells 11 that are located at opposite ends of the multiple battery cells 11 in the stack direction X. The middle battery cells 11 are ones of the multiple battery cells 11 located between the first end battery cell 11 and the second end battery cell 11 in the stack direction “X”. In this way, adjacent battery cells 11 in the stack direction “X” are electrically connected with each other. In other words, all of the battery cells 11 constituting the battery pack 1 are electrically connected in series with each other via the busbar so that a current flows in a zigzag or tortuous path from the terminal part 12 of the first end battery cell 11 to the terminal part 12 of the second end battery cell 11.

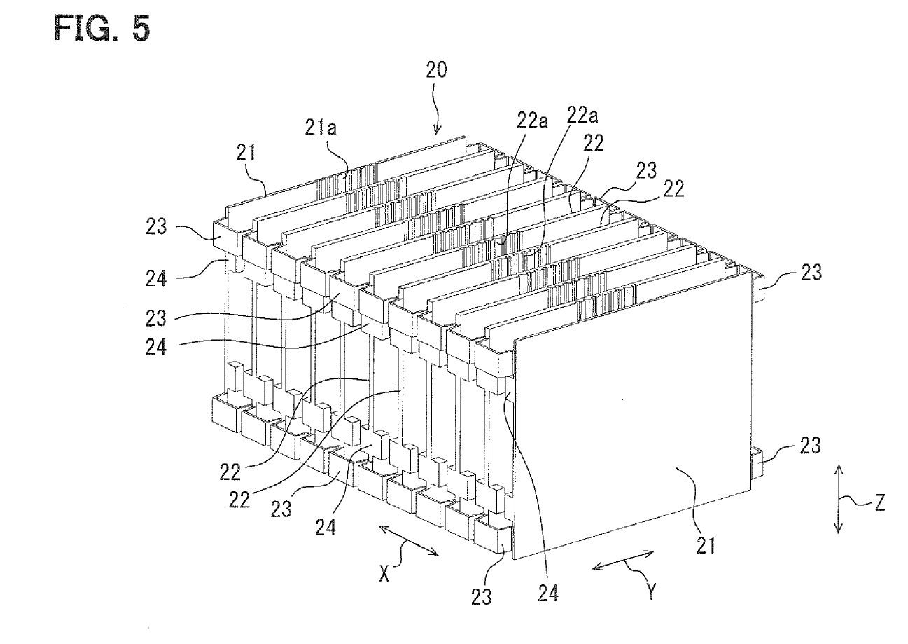

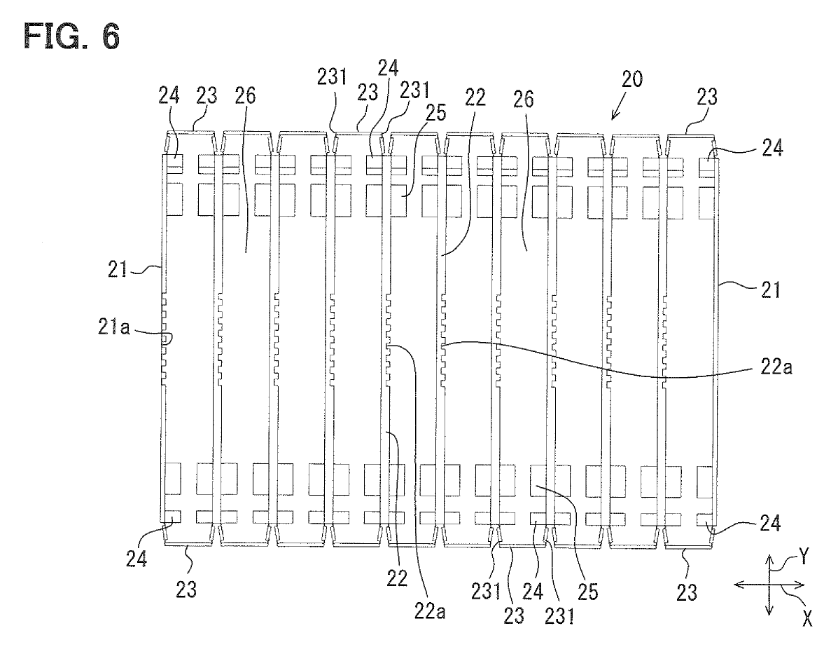

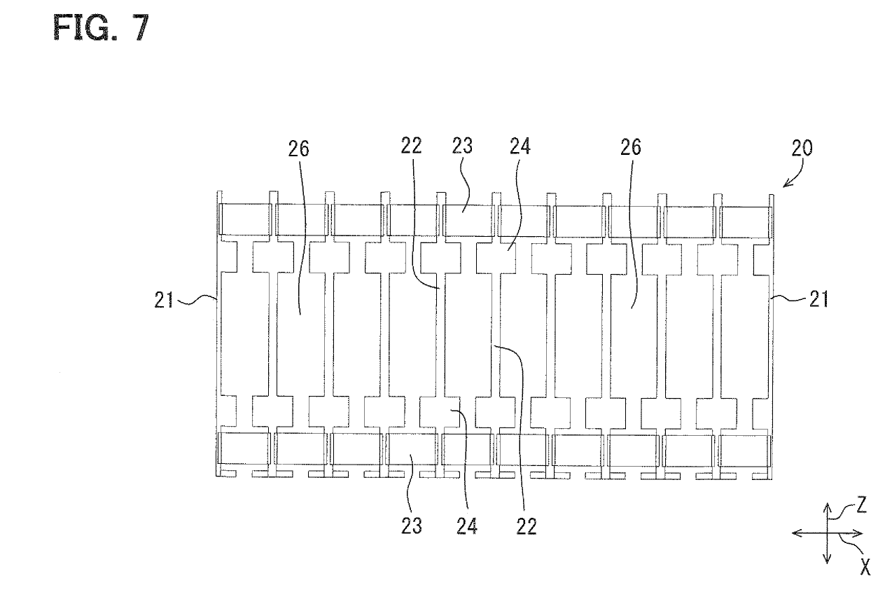

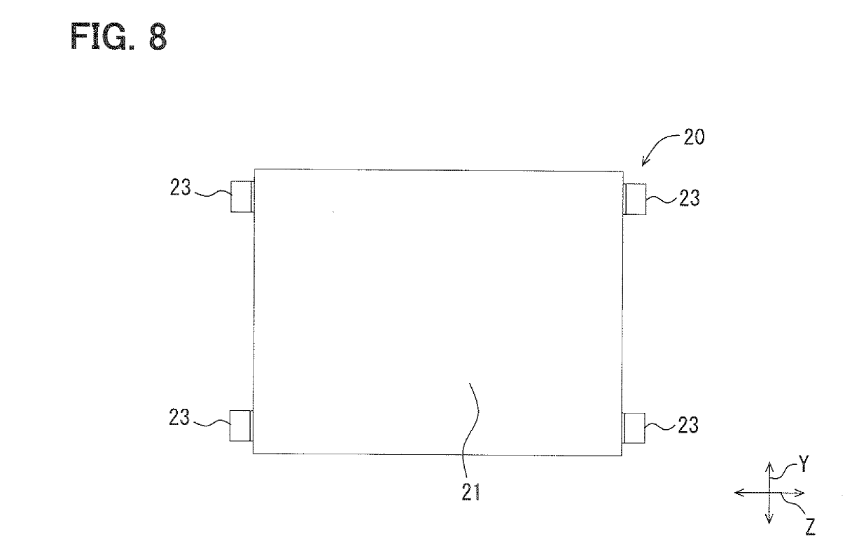

FIG. 5 is a perspective view of the battery holder device 20. FIG. 6 is a plan view of the battery holder device 20. FIG. 7 is a side view of the battery holder device 20 viewed in the longitudinal direction “Y”. FIG. 8 is a side view of the battery holder device 20 viewed in the stack direction “X”. Now, a configuration of the battery holder device 20 will be described with reference to FIGS. 5 to 8.

The battery holder device 20 includes surface pressing members 21, 22 and connection members 23. The surface pressing members 21, 22 and the connection members 23 are integrally formed. The surface pressing members 22 are interposed between the battery cells 11. The multiple battery cells 11 are interposed between the surface pressing members 21 in the stack direction “X”. In this way, the surface pressing members 21, 22 are arranged to press the side surfaces, which are normal to the stack direction “X” and parallel to the longitudinal direction “Y” and the height direction “Z”, of the battery cells 11. Each connection member 23 connects adjacent surface pressing members 22, 21, which are adjacent to each other in the stack direction “X”. The battery holder device 20 can be made of any insulating resin. For example, the battery holder device 20 may be made of polypropylene, polyethylene, polystyrene, chloride, fluorine resin, polybutylene terephthalate (PBT), polyimide (e.g., nylon), polyimide-imide resin (PAI resin), acrylonitrile-butadiene-styrene resin (ABS resin: acrylonitrile butadiene styrene copolymerized synthetic resin), polyacetal, polycarbonate, polyethylene terephthalate, polyphenylenesulfide, phenol, epoxy, acrylic or the like.

The surface pressing members 22 are multiple plate-shaped members and are arranged at predetermined intervals in the stack direction “X”. The two surface pressing members 21 are located outside the surface pressing members 22 with respect to the stack direction “X”. More specifically, one surface pressing member 21 is positioned outwardly from one outermost surface pressing member 22 with respect to the stack direction “X” so that the one surface pressing member 21 and the one outermost surface pressing member 22, which is positioned outermost among the multiple surface pressing members 22, are spaced apart from each other by the predetermined interval in the stack direction “X”. The other surface pressing member 21 is located outwardly from the other outermost surface pressing member 22 with respect to the stack direction “X” so that the other surface pressing member 21 and the other outermost surface pressing member 22, which is also positioned outermost among the multiple surface pressing members 22, are spaced apart from each other by the predetermined interval in the stack direction “X”. The surface pressing members 21 can serve as two end plate members that press opposite end faces of the multiple stacked battery cells 11, respectively.

The predetermined interval is set comparable to or slightly larger than the thickness size of the battery cell 11 in the stack direction “X”. The predetermined interval corresponds to length of a battery cell arrangement space 26 in the stack direction “X”. In the above, the battery cell arrangement space 26 is a space defined between adjacent surface pressing members 22 (22, 21). More specifically, multiple battery cell arrangement spaces 26 are arranged in the stack direction “X” so that the multiple battery cell arrangement spaces 26 and the multiple surface pressing members 22 are alternately arranged. In each of the battery cell arrangement spaces 26, the exterior case as a whole of one battery cell 11 is received. Side surfaces of the exterior case, which are opposite to each other in the stack direction “X”, are closely attached to the surface pressing members 22 (22, 21) and the side surfaces of the exterior case as a whole are subjected to pressing forces.

Multiple grooves 22a are formed on a center portion, with respect to the longitudinal direction “Y”, of one or both of the side surfaces of each surface pressing member 22. Each of the multiple grooves 22a extends along the height direction “Z”. The multiple grooves 22a are arranged and spaced apart from each pother in the longitudinal direction “Y”. The surface pressing members 21, which are positioned at opposite end portions of the battery holder device 20, have also thereon multiple grooves 21a so that the multiple grooves 21a have the substantially same shape as the multiple grooves 22a. Each of the grooves 21a, 22a forms a gap between the battery cell 11 and the surface pressing member 21, 22 when the battery cell 11 is arranged in each battery cell arrangement space 26 and is subjected to the pressing force from the surface pressing member 22, 21. The grooves 21a, 22a can function as air passages, which conduct an air (wind) for cooling the side surfaces of the battery cells 11 when the air is blown to the battery pack 1.

Four first support members 24 are integrated with end portions of each surface pressing member 22, 21, so that two of the four first support members 24 are located on an opposite side of the surface pressing member 22, 21 from the other two of the four first support members 24 in the longitudinal direction “Y”. The two of the four first support members 24 are respectively located at an upper position and at a lower position on one end portion of the surface pressing member 22, 21. The other two of the four first support members 24 are respectively located at an upper position and at a lower position on the other end portion of the surface pressing member 22, 21. Each first support member 24 is a plate-shaped member and projects from the end portion (i.e., the end portion in the longitudinal direction “Y”) of the surface pressing member 22 toward two opposite directions parallel to the stack direction “X”. When the battery cell 11 is inserted into the battery cell arrangement space 26 from an upward, each first support member 24 supports the battery cell 11 so as to guide the end face of the exterior case of the battery cell 11 and regulate movement of the battery cell 11 in the longitudinal direction “Y”. One first support member 24 of one surface pressing member 22 can support two battery cells 11 arranged on opposite sides of the one surface pressing member 22.

A second support member 25 is formed at a lower end of each surface pressing member 22, 21 in the height direction “Z”. The second support member 25 is plate-shaped. The second support member 25 and the surface pressing member 22, 21 are integrally formed. Each second support member 25 projects from the lower end of the surface pressing member 22 toward two opposite direction parallel to the stack direction “X”. When the battery cell 11 is inserted into the battery cell arrangement space 26 from an upward, each second support member 25 touches and supports a bottom surface of the exterior case of the battery cell 11 so that the second support member 25 regulates a downward movement of the exterior case of the battery cell 11. One second support member 25 of one surface pressing member 22 can support two battery cells 11 arranged on both sides of the one surface pressing member 22.

The connection members 23 are integrated with the surface pressing members 22, 21. Some of the connection members 23 are formed to connect adjacent surface pressing members 22 to each other. Others of the connection members 23 are formed to connect the outermost surface pressing member 22, which is positioned outermost among the multiple surface pressing members 22, to the surface pressing member 21, which acts as the end plate member positioned outwardly from the outermost surface pressing member 22. More specifically, the connection members 23 are formed on the end portions, which are opposite to each other in the longitudinal direction “Y”, of the surface pressing members 22, 21. The connection members 23 are positioned outwardly from the first support members 24 with respect to the height direction “Z”, i.e., the connection members 23 are positioned upper or lower than the first support members 24 with respect to the height direction “Z”. As shown in FIG. 8, each connection member 23 is formed to project outwardly than an end face of the surface pressing member 22, 21 in the longitudinal direction “Y”.

Each connection member 23 includes a thin portion, thickness size of which is smaller than the thickness size of the surface pressing member 22. Each connection member 23 is U-shaped in cross section. The U-shape cross section may appear on a plane parallel to the stack direction “X” and the longitudinal direction Y, or on a plane parallel to the stack direction “X” and the height direction “Z”.

A corner portion 231 of the U-shaped connection member 23 is thinner than (i.e., is smaller in thickness than) other portions. Because of the thinness of the corner portion 231, when the compressing force is applied by the bracket 2 (a binding device or means) in a state where the battery cells 11 are in the battery cell arrangement spaces 26, it narrows spaces between the surface pressing members 22 and increases deflection of the connection members 23. That is, because of the above corner portion 231, the defection of the connection member 23 is facilitated.

Advantage of the battery pack 1 of the present embodiment will be described.

The battery pack 1 of the present embodiment is configured in the following way. The multiple angular-shaped battery cells 11 are stacked in the stack direction X. The battery holder device 20 integrates the multiple battery cells 11 by pressing the side surfaces, normal to the stack direction X, of the multiple battery cells 11 with a load acting along the stack direction X. The battery holder device 20 integrally includes multiple surface pressing members 22 and multiple connection members 23. The multiple surface pressing members 22 are interposed between the multiple battery cells 11 so that the multiple surface pressing members 22 press the side surfaces, which are normal to the stack direction X, of the multiple battery cells 11. Each of the multiple connection members 23 connects adjacent surface pressing members 22, which are adjacent to each other in the stack direction X. Rigidity of each connection member 23 against the load acting along the stack direction X is smaller than rigidity of each surface pressing member 22 against the load acing along the stack direction X.

According to the above configuration, since the rigidity of the connection member 23 against the load acting along the stack direction “X” is smaller than the rigidity of the surface pressing member 22 against the load acting along the stack direction “X”, the connection members 23 having the small rigidity can be easily deflected when an external force acts on the side surfaces, normal to the stack direction “X”, of the surface pressing member 22 to bind the battery pack 1 with a binding force, which compresses the battery pack 1 from both sides of the battery pack 1 in the stack direction “X”. Thus, the surface pressing members 22 are compressed to closely contact with the side surfaces of the battery cells 11 with no influence of the rigidity of the connection member, it is possible to attain close contact between each battery cells 11 and corresponding surface pressing members 22, and it is possible to bind all of the stacked battery cells in a convincing way. Therefore, it is possible to provide measures against a thickness size variation of battery cells 11, and further, it is possible to provide a binding force sufficient to integrate multiple battery cells 11.

The above battery pack 1 may be configured so that the load acting along the stack direction X deforms each connection member 23 and narrows an interval between adjacent surface pressing members 22. According to this configuration, since deformation of each connection member 23 by the load acting along the stack direction X narrows an interval between the adjacent surface pressing members 22, the binding force acting on the battery pack 1 compress the battery cells 11 in accordance with a decrease in the interval between the adjacent surface pressing members 22. Therefore, it is possible to reliably apply pressure from the surface pressing members 22 to the side surfaces of every battery cell 11, and it is possible to reliably bind all of the battery cells 11 of the battery pack 11.

Moreover, according to the related art, in stacking angular-shaped battery cells 11, it may be necessary to fasten a group of battery cells while applying a pressing force from an outside of the group of battery cells by using a case from viewpoint of vibration proof. According to the battery pack 1 of the present embodiment, since it is possible to fasten a group of battery cells by using the above-described battery holder device 20, it is unnecessary to fasten a group of battery dells by using a case.

The battery pack 1 of the present embodiment may be configured so that length of the each connection members 23 in the stack direction X is larger than an amount of change in the interval between the adjacent surface pressing members 22 in cases where the load acting along the stack direction X changes the interval. According to this configuration, when the binding force acts on the battery pack 1 and when the load acting along the stack direction changes the interval between the adjacent surface pressing members 22, an amount of resultant change in the interval between the adjacent surface pressing members 22 is smaller than the length of the connection member 23 in the stack direction X. Therefore, it is possible to relax stress acting on the connection member 23. This has a great impact on damage prevention of the connection members 23.

Moreover, the battery pack 1 of the present embodiment may be configured so that the connection member 23 of the battery pack 1 has the thin portion, the thickness size of which is smaller than that of the surface pressing member 22. According to this configuration, since the thin portion is formed in the connection member 23, the connection member 23 can be more easily deflected at the thin portion. Thus, in binding the battery pack 1, it is possible to efficiently use the binding force, which compresses the surface pressing member 22, as a pressing force for the surface pressing member 22 to press the battery cells 11. Therefore, an allowable amount of deflection of the connection member 23 at a time of the binding can be increased. In the above, the connection member 23 as a whole may be formed as the thin portion. Alternatively, the thin portion may be formed thinner than (smaller in thickness size than) other portion of the connection member 23.

Moreover, the battery pack 1 of the present embodiment may be configured so that the connection member 23 is U-shaped in cross section. According to this configuration, even if the binding force is smaller, the connection member 23 can be easily deflected at a U-shaped thin portion. Therefore, even when the thickness size varies among the battery cells 11, it is possible to apply a desired binding force to all of the battery cells 11.

The connection member 23 may be configured to have a corner portion 231, which is smaller in thickness than other portions of the connection member 23. In this configuration, since the corner portion 231 of the connection member 23 is smaller in thickness than either portions of the connection member 23, the compressing force acting on the surface pressing members 22 along the stack direction “X” can certainly deflect the connection member 23 due to deformation of the corner portion 231. Thus, it is possible to efficiently use the compressing force on the surface pressing member 22 as a pressing force, with which the surface pressing member 22 press the battery cell 11. Therefore, the compressing force applied from the binding device etc. to the battery pack 1 can be efficiently converted to the binding force on each battery cell 11.

### Second Embodiment

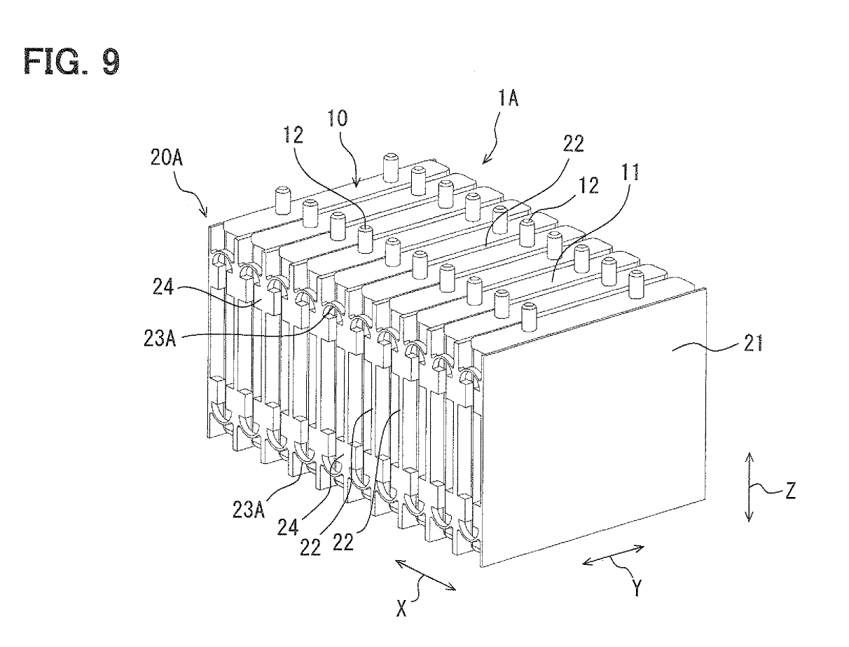

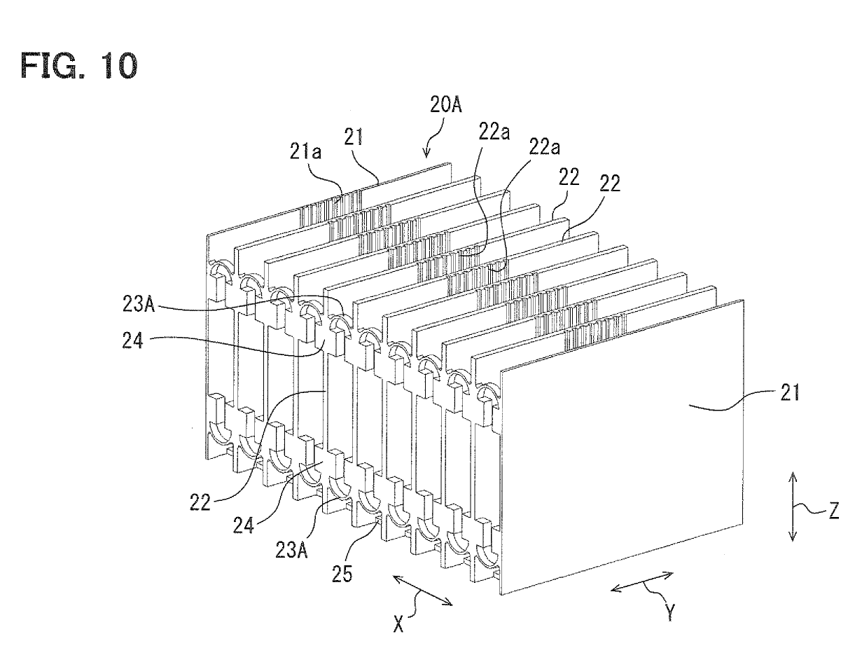

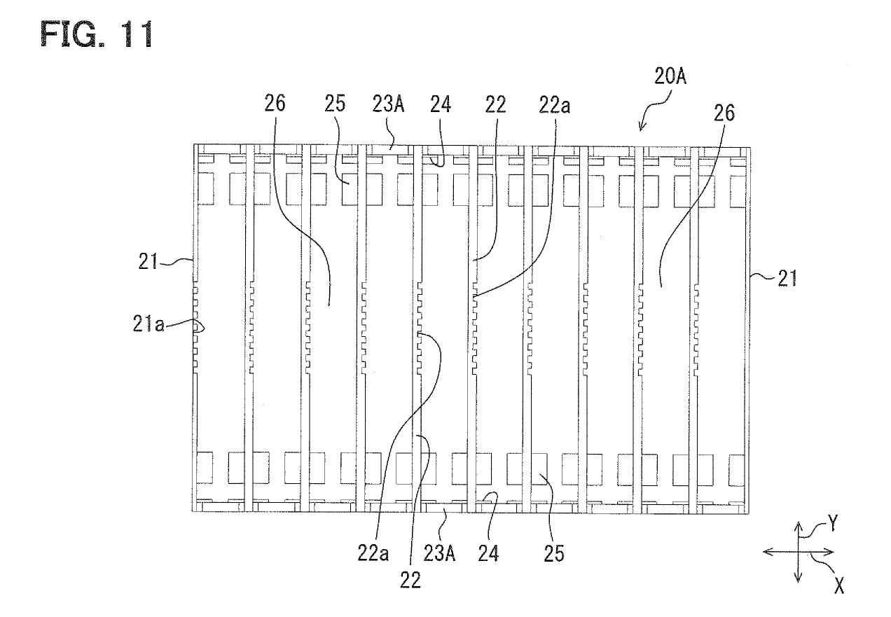

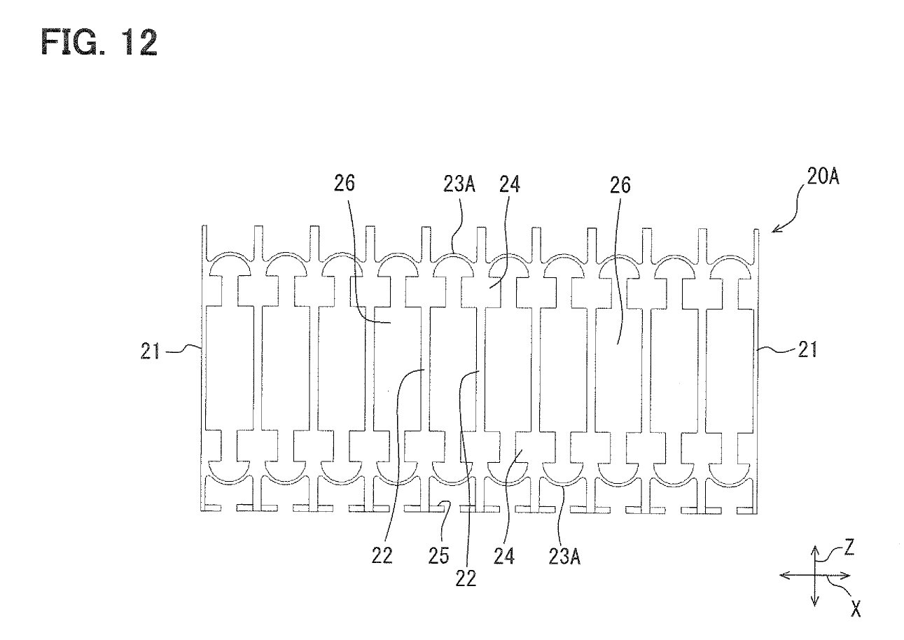

A battery pack 1A provided with a battery holder device 20A of a second embodiment will be described below with reference to FIGS. 9 to 12. FIG. 9 is a perspective view of the battery pack 1A of the second embodiment. FIG. 10 is a side view of the battery holder device 20A. FIG. 11 is a plan view of the battery holder device 20A. FIG. 12 is a side view of the battery holder device 20A viewed in the longitudinal direction “Y”. As shown in FIGS. 9 to 12, a direction in which multiple battery cells 11 are stacked and arranged is defined as the stack direction “X”. A direction in which each rectangular battery cell 11 is elongated is defined as a longitudinal direction “y” A direction perpendicular to both of the stack direction “X” and the longitudinal direction. “Y” is defined as a height direction “Z” (also called a vertical direction “Z” or an upper/lower direction “Z”).

The battery holder device 20A of the second embodiment is different from the battery holder device 20 of the first embodiment in configuration of the connection member 23A. As for an advantage in connection with similar configurations between the first embodiment and the present embodiment, the second embodiment can have the same advantage as the first embodiment. Now, a different point from the first embodiment will be described.

The connection members 23A are integrated with the surface pressing members 22, 21. Some of the connection members 23A are formed to connect the adjacent surface pressing members 22 to each other. Others of the connection members 23A are formed to connect the outermost surface pressing member 22, which is located outermost among the multiple surface pressing members 22 with respect to the stack direction “X”, to the surface pressing member 21, which acts as the end plate member located outwardly from the outermost surface pressing member 22 with respect to the stack direction “X”. More specifically, the connection members 23A are formed on the end portions, which are opposite to each other in the longitudinal direction “Y”, of the surface pressing members 22, 21. The connection members 23A are located outwardly from the first support members 24 with respect to the height direction “Z”, i.e., the connection members 23A are positioned upper or lower than the first support members 24 along the height direction “Z”. As shown in FIG. 11, in the longitudinal direction “Y”, each connection member 23A is located to coincide with an end face of the surface pressing member 22, 21. Further, in the longitudinal direction “Y”, each connection member 23A also coincides with the first support member 24. Further, each connection member 23A faces onto the battery cell arrangement space 26. Therefore, each connection member 23A as a whole is received between the adjacent surface pressing members 22. Unlike the connection member 23 of the first embodiment, the connection member 23A does not project outwardly.

Each connection member 23A has a thin portion, which is smaller in thickness size than the surface pressing member 22. The connection member 23A may be curved in cross section. The curved cross section of the each connection member 23A may appear on a plane parallel to the stack direction “X” and the longitudinal direction Y, or on a plane taken parallel to the stack direction “X” and the height direction “Z”.

The connection member 23A may be formed so that a curved portion of the connection member 23A is smaller in thickness size than other portions of the connection member 23A. In this case, because of the thinness of the curved portion, when the compressing force along the stack direction “X” is applied by the bracket 2 (an example of a binding means) in a state where the battery cells 11 are in the battery cell arrangement spaces 26, the intervals between the surface pressing members 22 are narrowed, and the connection members 23A become more easily deflected at the curved portions. That is, since the connection member 23A has the curved portion, the deflection of the connection member 23A is facilitated.

Advantages of the battery pack 1A of the present embodiment will be described.

The battery holder device 20A of the battery pack 1A is configured to have the thin portion, which is curved in cross section. According to this configuration, even if the binding force acting on the battery pack 1A is small, the connection member 23A can be easily deflected at the curved thin portion. Therefore, even when the thickness size varies among the battery cells 11, it is possible to apply a desired binding force to all of the battery cells 11.

In the battery pack 1A, the connection member 23A is provided so as to be received between the adjacent surface pressing members 22. According to this configuration, since the connection member 23A, which is deflected at a time of the binding of the battery pack 1A, does not project into an outside of the surface pressing members 22, the battery pack 1A occupies a small volume, and the downsizing of the battery pack 1A can improve mountability.

In the battery pack 1A, the length of the connection member 23A in the stack direction “X” is larger than an amount of change in the interval between the adjacent surface pressing members 22 in cases where the load acting along the stack direction “X” changes the interval. In this configuration, when the binding force acts on the battery pack 1A, the load acting on the stack direction X change the interval between the adjacent surface pressing members 22. However, this amount of change in the interval between the adjacent surface pressing members 22 becomes smaller than the length of the connection ember 23A in the stack direction “X”. Therefore, it is possible to decrease a ratio of (i) an amount of deflection of the connection member 23A in the stack direction “X” to (ii) the length of the connection member 23A in the stack direction “X”. Therefore, it is possible to relax the stress on the connection member 23A and it is possible to prevent damage of the connection member 23A.

### Third Embodiment

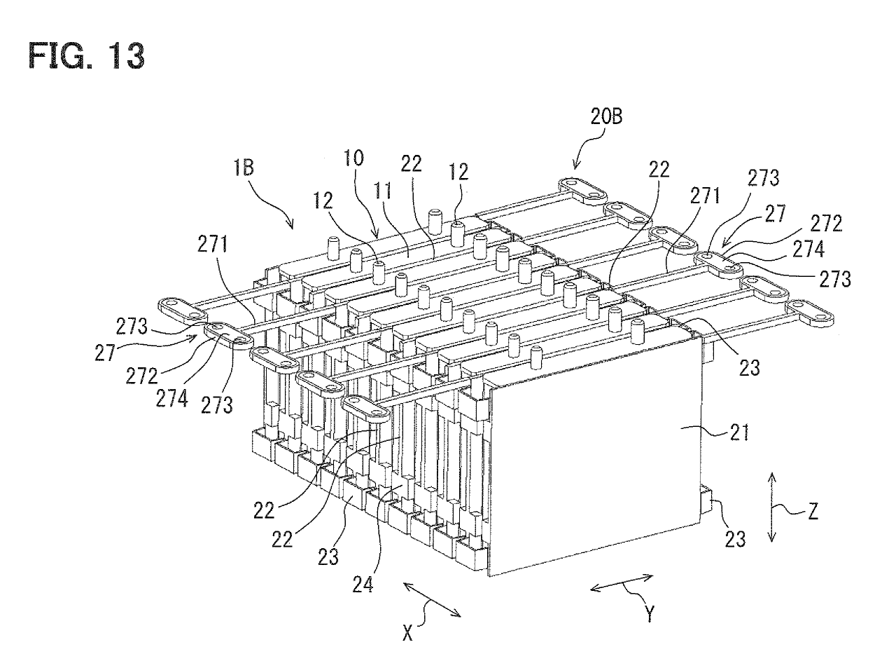

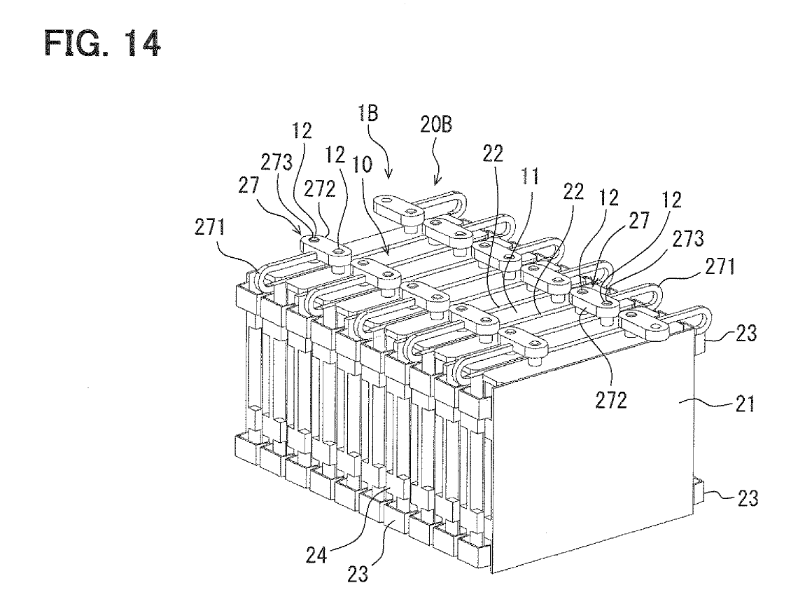

A battery pack 1B with a battery holder device 20B of a third embodiment will be described below with reference to FIGS. 13 to 14. FIG. 13 is a perspective view of the battery pack 1B before a busbar 274 is mounted to the terminal parts 12 of the battery cells 11. FIG. 14 is a perspective view of the battery pack 1B after the busbar 274 is mounted to the terminal parts 12 of the battery cells 11. As shown in FIGS. 13 to 14, a direction in which multiple battery cells 11 are stacked and arranged is defined as the stack direction “X”. A direction in which each rectangular battery cell 11 is elongated is defined as a longitudinal direction “Y”. A direction perpendicular to both of the lamination direction “X” and the longitudinal direction “Y” is defined as a height direction “Z” (also called a vertical direction “Z”).

The battery holder device 20B of the present embodiment is different from the battery holder device 20 of the first embodiment in that the battery holder device 20B includes a busbar mounting member 27. As for an advantage in connection with similar configurations between the first embodiment and the present embodiment, the third embodiment can have the same advantage as the first embodiment. Now, a difference from the first embodiment will be described.

Each busbar mounting member 27 includes a reception portion 272 and a linkage portion 271, which are integrally formed. The reception portion 272 enables the busbar 274 to be mounted. The linkage portion 271 connects between the reception portion 272 and the surface pressing member 22. The busbar mounting member 27 is integrated with the surface pressing member 22. The busbar mounting member 27 is made of the same or similar insulating resin as the battery holder device 20. The reception portion 272 has a size and a shape to receive the busbar 274, and has a concave portion and a positioning portion for mounting the busbar 274. Alternatively, by insert-molding or the like, the reception portion 272 may be formed to previously receive the busbar 274. The busbar 274 has a through-hole into which the terminal part 12 of the battery cell 11 is insertable. The reception portion 272 has an opening 273 corresponding to the through-hole of the busbar 274.

The linkage portion 271 is rod-shaped. As shown in FIG. 14, the linkage portion 271 has such rigidity that the linkage portion 271 is easily elastically deformable and can be bend by an external force greater than or equal to a predetermined value (e.g., can be bend by a human-hand-working external force). A material or a rod diameter of the linkage portion 271 may be appropriately set so that the linkage portion 271 has the above rigidity. That is, the linkage portion 271 has such rigidity and flexibility that facilitate positioning the busbar 274 and the terminal part 12 in mounting the busbar 274 to each terminal part 12.

Advantages of the present embodiment will be described.

According to the battery holder device 20B of the battery pack 18, since the busbar mounting member 27 is integrated with the battery holder device 208, it is possible to reduce man-hour for mounting the busbar to the terminal part 12.

The busbar mounting member 27 integral with the battery holder device 20B may be made of a material having an excellent insulating property. In this case, since a cover for insulating the busbar is not required as an additional part, it is possible to provide the battery pack 18 that can ensure insulation and that can reduce the number of parts and an amount of management man-hour.

Moreover, if the busbar 274 is integrated with the busbar mounting member 27 of the battery holder device 208, it is possible to reduce an amount of man-hour for managing the busbar and an amount of man-hour required to mount the busbar to the terminal part 12 because the busbar is not a separated part. It is therefore possible to improve productivity of the battery pack.

### Fourth Embodiment

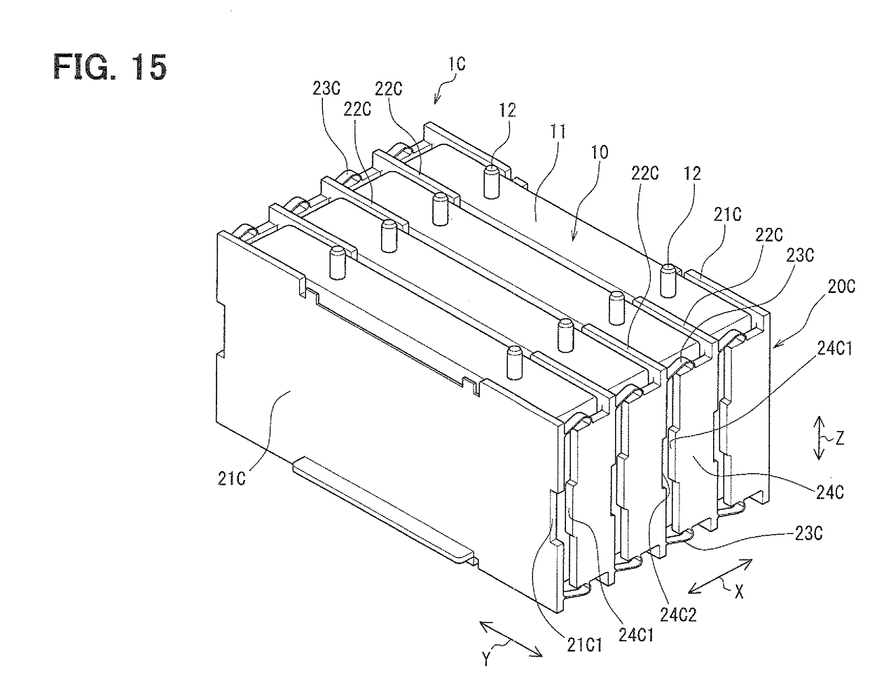

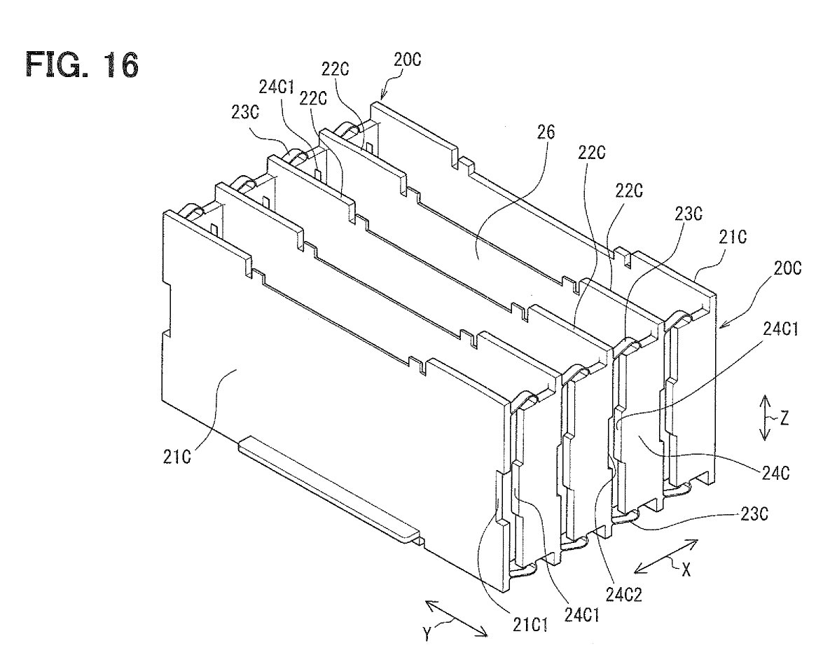

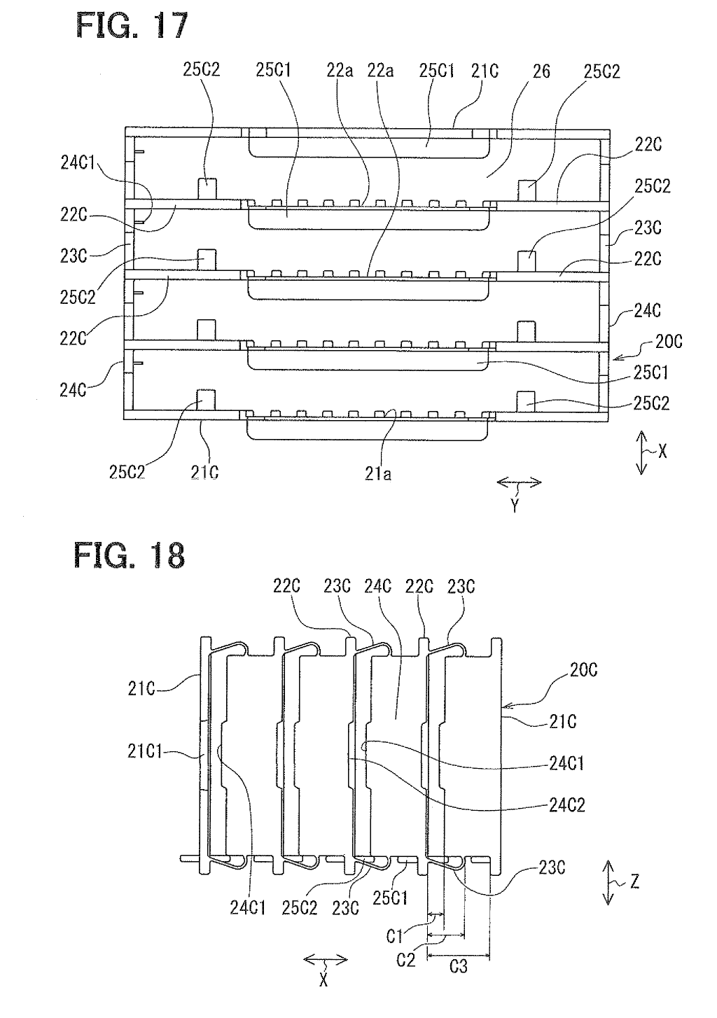

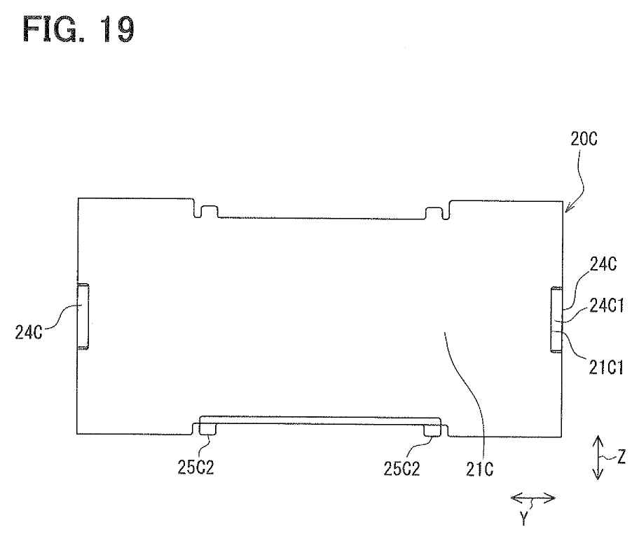

A battery pack 1C provided with a battery holder device 20C of a fourth embodiment will be described below with reference to FIGS. 15 to 19. The battery holder device 20C of the fourth embodiment is different in configuration from the battery pack 20 of the first embodiment. FIG. 15 is a perspective view of the battery pack 1C of the fourth embodiment. FIG. 16 is a perspective view of the battery holder device 20C used in the battery pack 1C. FIG. 17 is a plan view of the battery holder device 20C. FIG. 18 is a side view of the battery holder device 20C viewed in the longitudinal direction “Y”. FIG. 19 is a side view of the battery holder device 20C viewed in the stack direction “X”. It should be noted that FIG. 15 illustrates a state before the binding force is applied to the battery pack 1C. As shown in FIGS. 15 to 19, a direction in which multiple battery cells 11 are stacked and arranged is defined as the stack direction “X”. A direction in which each rectangular battery cell 11 is elongated is defined as a longitudinal direction “Y”. A direction perpendicular to both of the stack direction “X” and the longitudinal direction “Y” is defined as a height direction “Z” (also called a vertical direction “Z” or an upper/lower direction “Z”).

The battery holder device 20C of the present embodiment is different from the battery holder device 20 of the first embodiment in a connection member 23C etc. As for an advantage in connection with similar configurations between the first embodiment and the present embodiment, the present embodiment can have the same advantage as the first embodiment. Now, a different point from the first embodiment will be described.

As shown in FIGS. 15 to 19, the connection members 23C are integrated with the surface pressing members 22C. Some of the connection members 23C are formed to connect adjacent surface pressing members 22C, which are adjacent to each other in the stack direction “X”. Others of the connection members 23C are formed to connect an outermost surface pressing member 22C, which is positioned outermost among the multiple surface pressing members 22C, to a surface pressing member 21C, which acts as the end plate member positioned outwardly from the outermost surface pressing member 22C. More specifically, the connection members 23C are formed on end portions, which are opposite to each other in the longitudinal direction “Y”, the surface pressing member 22C, 21C. The connection members 23 are positioned outwardly from first support members 24C with respect to the height direction “Z”, i.e., the connection members 23C are positioned upper or lower than the first support members 24C with respect to the height direction “Z”.

First support members 24C are located on opposite end portions, which are opposite to each other in the longitudinal direction “Y”, of the surface pressing members 22C. Each first support member 24C is a plate-shaped member and projects from the end portion of the surface pressing member 22C in the stack direction “X”. Each first support member 24C also acts as a wall member that connects between two connection members 23C, one of which is located upper in the height direction “Z”, and the other of which is located lower in the height direction “Z”. Adjacent first support members 24C, which are adjacent to each other in the stack direction “X”, are connected by the upper connection member 23C and the lower connection member 23C. When the battery cell 11 is inserted into the battery cell arrangement space 26 from an upward, each first support member 24C supports an end face of the exterior case of the battery cell 12 in the longitudinal direction “Y” so as to guide the end face of the exterior case and regulate movement of the end face in the longitudinal direction “Y”.

As shown in FIG. 17, a rib 24C1 is formed on an inner wall surface of one of the two first support members 24C located opposite to each other in the longitudinal direction “Y”, so that the rib 2401 projects inward. When the battery cell 11 is inserted into the battery cell arrangement space 26 from an upward, this rib 24C1 contacts and guides the end face of the battery cell 1 in the longitudinal direction “Y; thereby, together with the first support member, the rib 24C1 supports the battery cell 11 so as to regulate movement of the battery cell 11 in the longitudinal direction “Y”.

A second support member 2501 is formed at a lower end of the surface pressing member 22C, 21C in the height direction “Z”. The second support member 25C1 is plate-shaped. The second surface member 25C1 and the surface pressing member 22C, 21C are integrally formed. Each second support member 25C1 projects from the lower end of the surface pressing member 22C, 21C in the stack direction “X”. Two third support members 2502 are further formed at the lower end, with respect to the height direction “Z”, of the surface pressing member 22C, 21C that faces another surface pressing member 220, 21C having the second support member 25C1. The two third support members 25C2 are located on opposite sides of the grooves 22a, 21a so as to be spaced apart in the longitudinal direction “Y as shown in FIG. 17. When the battery cell 11 is inserted and installed into the battery cell arrangement space 26 from an upward, one second support member 25C1 and two third support member 25C2 contact with the exterior case of the battery cell 11 and support the battery cell 11 at three points, respectively, so as to regulate the downward movement of the battery cell 11.

As shown in FIG. 17, two connection members 23C are formed on each surface pressing member 22C, 21C so that two connection member 230 coincide with opposite end faces, which are opposite to each other in the longitudinal direction “Y”, of the each surface pressing member 22, 21. In addition, each connection member 23A also coincides with the first support member 24C in the longitudinal direction “Y”. The connection member 23A is located to face onto the battery cell arrangement space 26. That is, each connection member 23C as a whole is provided so as to be received between the adjacent surface pressing members 22C. The connection member 230 does not project into an outside of the surface pressing members 22C. Note that the connection member 23 of the first embodiment projects into an outside of the surface pressing members 22.

As shown in FIG. 18, length C2 of the connection member 230 in the stack direction “X” is larger than length C1, which is an amount of change in interval between adjacent surface pressing members 22C when the load acting along the stack direction “X” changes the interval. In addition, the length C2 is smaller than length C3, which is a distance between the adjacent surface pressing members 22C.

Each connection member 23C has a thin portion, which is smaller in thickness size than the surface pressing member 22C. The connection member 23C may be curved in cross section. The curved cross section appears on a plane parallel to the stack direction “X” and the height direction “Z”. The shape of the cross section of the connection member 23C is asymmetric with respect to the stack direction “X”, so the location of the curved portion is deviated from a center toward an end of the connection member 23C in the stack direction “X”. As shown in FIG. 18, the connection member 23C as a whole may be thin and may act as the thin portion. Alternatively, a certain portion of the connection member 23C may be thin and may act as the thin portion. The thin portion of the connection member 23C may be smaller in thickness size than the other portions of the connection member 23C.

Alternatively, a curved portion of each connection member 23C may act as the thin portion that is smaller in thickness size than the other portions of the connection member 23C. Because of the thinness of the curved portion, when the compressing force along the stack direction is applied by the binding device in a state where the battery cells 11 are in the battery cell arrangement spaces 26, it narrows spaces between the surface pressing members 220 and makes the connection members 23C easily deflected at the curved portion. That is, since the connection member 23C has the curved portion, the deflection of the connection member 23C is further facilitated.

An engagement convex part 24C1 is formed on one of opposite end faces, which are opposite to each other in the stack direction “X”, of each first support member 24C. The engagement convex part 2401 projects in the stack direction “X”. An engagement concave part 24C2 is formed on the other of the opposite end faces of the each first support member 24C. The engagement concave part 24C2 has such a size that the engagement concave part 2402 can fit into an adjacent engagement convex part 24C1. An engagement convex part 21C1 is formed on one end face, which is normal to the stack direction “X”, of the surface pressing member 21C. The engagement convex part 21C1 has such a size that the engagement convex part 21C1 can fit into the adjacent engagement convex part 24C1.

When the binding device or the like applies the binding force to the battery pack 1C, the compressing force acts on the surface pressing members 21C, 22C and deforms the connection members 23C; as a result, the distance between adjacent surface pressing members becomes small. When a displacement amount of the surface pressing member 22C in the stack direction “X” becomes comparable to the length C1 illustrated in FIG. 18, the engagement convex parts 24C1 of the first support members 24C engage with and fit into corresponding adjacent engagement concave parts 24C2 or corresponding adjacent engagement convex parts 24C1. Because of this engaging state, it is possible to restrict positions of the surface pressing members 22C, and it is possible to put the surface pressing members 22C in a stable position against the binding force.

Advantages of the battery pack 1C of the present embodiment will be described.

The battery holder device 20C is a resin molding part. The length of the connection member 23C in the stack direction “X” (see “C2” in FIG. 18) is smaller than a distance between the adjacent surface pressing members 22C (see “C3” in FIG. 18).

When the connection member 23C, which has an easily-deformable structure, is large in length in the stack direction “X”, it may be typically difficult to allow a resin material to sufficiently flow into a mold at a time of molding such as injection molding and the like, and it may be difficult to manufacture a product ensuring a desired quality in strength and size. However, in the present embodiment, since the length of the connection member 23C in the stack direction “X” is smaller than a distance between the adjacent surface pressing members 22C, the resin material can go around inside the mold in a favorable manner. Therefore, it is possible to ensure a desired amount of strength and a desired amount of deflection, and it is possible to provide the connection member 23C causing the foregoing advantage.

As shown in FIG. 18, the length C2 of the connection member 23C in the stack direction “X” is larger than a change amount C1, which is an amount of change in the interval between adjacent surface pressing members 22C when the load acting along the stack direction “X” changes the interval. In this configuration, when the binding force is applied to the battery pack 1C and when the load acting in the stack direction “X” changes the interval between adjacent surface pressing members 22C, an amount of change in the interval is not larger than the length of the connection member 23C in the stack direction “X”. Thus, a ratio of the deflection amount to the length of the connection member 23C in the stack direction “X” can be suppressed. Therefore, it is possible to relax the stress on the connection member 23C and it impossible to prevent damage of the connection member 23C.

The connection member 23C is provided so as to be received between adjacent surface pressing members 22C. In this configuration, the connection member 23C, which is deflected when the battery pack 1C is bound, does not project into an outside of the surface pressing members 22C. Therefore, the volume occupied by the battery pack 1C is small. This downsizing increases mountability.

### Other Embodiments

The above embodiments can be modified in various ways, examples of which will be described below.

In the above embodiments, the grooves 21a and 22b are formed on the center portion, which is centered with respect to the longitudinal direction “Y”, of one of or both of the side surfaces of the surface pressing member. Alternatively, the grooves 21a and 22b may be formed on another portion of one of or both of the side surfaces of the surface pressing member. The surface pressing member may be made of a high thermal conductive material. In this case, an air may be blown to the battery holder device 20, 20A, 20C so that heat radiation from the battery holder device itself cools the battery pack 1, 1B, 1C. Alternatively, the surface pressing member may not be provided with the groove.

The connection members 23, 23A may be integrated with the surface pressing members 22, 21, so that the connection members 23, 23A are located on the opposite end portions, which are opposite to each other in the longitudinal direction “Y”, of the surface pressing member 22, 21; and, in the height direction Z″, as compared with the first support members 24, the connection members 23, 23A are located closer to the center of the surface pressing member 22, 21.

In the second embodiment, the connection member 23A has the curved portion, which is convexed toward the outside of the battery pack 1B in the height direction “Z”. However, the curved portion may be convexed in other manners. For example, the curved portion may be convexed toward the inside of the battery pack along the height direction “Z”. Alternatively, the curved portion may be convexed toward the inside or outside of the battery pack in the longitudinal direction “Y”.

In the fourth embodiment, the connection member 23C has the curved portion, which is convexed toward the outside of the battery pack in the height direction “Z” (e.g., in a lower direction or an upper direction). However, the curved portion may be convexed in other manners. For example, the curved portion may be convexed toward the inside of the battery pack 1B in the height direction “Z”. Alternatively, the curved portion may be convexed toward the inside or the outside of the battery pack in the longitudinal direction “Y”.

While the invention has been described above with reference to various embodiments thereof, it is to be understood that the invention is not limited to the above described embodiments and constructions. The invention is intended to cover various modifications and equivalent arrangements.

What is claimed is:

1. A battery pack comprising:
a plurality of angular-shaped battery cells that is stacked in a stack direction; and
a battery holder device that presses side surfaces, which are normal to the stack direction, of the plurality of battery cells with a load acting along the stack direction to integrate the battery pack,
wherein:
the battery holder device integrally includes
a plurality of surface pressing members each interposed between adjacent battery cells so that the plurality of surface pressing members presses the side surfaces, which are normal to the stack direction, of the plurality of battery cells, and
a plurality of connection members each connecting adjacent surface pressing members, which are adjacent to each other in the stack direction; and
rigidity of each connection member against the load acting along the stack direction is smaller than rigidity of each surface pressing member against the load acing along the stack direction.

2. The battery pack according to claim 1, wherein:
the each connection member is deformed by the load acting along the stack direction to narrow an interval between the adjacent surface pressing members.

3. The battery pack according to claim 1, wherein:
length of the each connection members in the stack direction is larger than an amount of change in the interval between the adjacent surface pressing members in cases where the load acting along the stack direction changes the interval.

4. The battery pack according to claim 1, wherein:
the battery holder device is a resin molding;
length of the each connection member in the stack direction is smaller than a distance between the adjacent surface pressing members.

5. The battery pack according to claim 1, wherein:
each connection member is curved in cross-section.

6. The battery pack according to claim 1, wherein:
each connection member is U-shaped in cross-section.

7. The battery pack according to claim 1, wherein:
each connection member includes a thin portion, size of which is smaller than thickness of the surface pressing member.

8. The battery pack according to claim 1, wherein:
each connection member includes a thin portion, thickness of which is smaller than the other portions of the each connection member.

9. The battery pack according to claim 1, wherein:
the each connection member is arranged so as to be received between the adjacent surface pressing members.
